(19) United States
(12) Patent Application Publication
(10) Pub. No.: US 2007/0132796 A1
(43) Pub. Date: Jun. 14, 2007

(54) Print again assembly

(76) Inventors: Anne Jovanovic, North York (CA); Srdjan Jovanovic, North York (CA)

Correspondence Address: Anne Jovanovic;Srdjan Jovanovic, 467 Ellerslie Avenue, North York, ON, M2R 1C3, CA

(21) Appl. No.: 11/297,382

(22) Filed: Dec. 9, 2005

(51) Int. Cl. B41J 29/38

(52) U.S. Cl. 347/14

(57) ABSTRACT

An paper recycling and reclaiming system designed for paper copiers and printers or independent use. In one embodiment, the recycling paper system, will include the paper feeder, scanner, printer for same paper color printing (typically white) which could be externally or internally added to conventional copier or printer or used independently for general paper recycling and reclaiming.

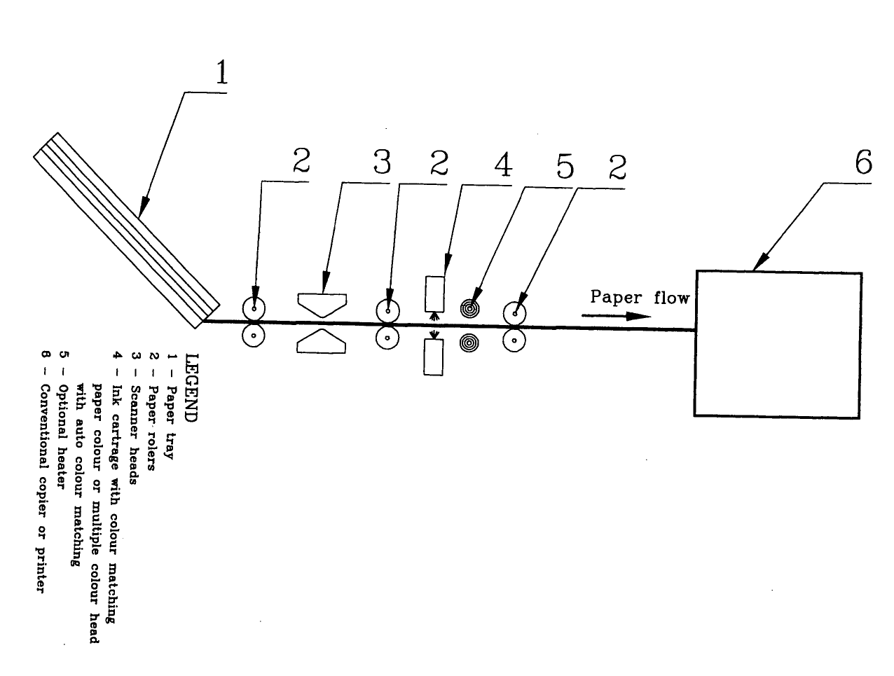

### BACKGROUND OF INVENTION

Conventional copiers and printers are not able to correct the mistakes or reclaim used paper sheets. Most of the times for one single error or for the fact the existing information is no more needed the paper sheets are thrown in to the garbage or some times send through long process of recycling in major recycling facilities. However if effective system could be put in place for instant paper reclaim the new paper usage will be significantly reduced. Most of current inventions that are dealing with paper recycling are based on paper de-inking designed for big paper recycling plants. Patents applications like #20050112387, 20040016522, 20040062879, 20020179261 and U.S. Pat. No. 6,277,208, 6,241,849, 6,217,706, 6,197,153, 6,022,423, 568,952, 5,601,689, are mostly dealing with paper fiber separation and paper de-inking in the high speed paper manufacturing environment. There are two patents U.S. Pat. Nos. 5,731,034 and 6,517,941 which are dealing with paper coating but very different methods from ones proposed. Also there are two patents U.S. Pat. Nos. 6,017,386 and 5,922,115 which are dealing with decolorizable ink and printer application in the manner to achieve decolorization of the paper prior to the reuse.

### BRIEF SUMMARY OF INVENTION

The present invention relates to an apparatus designed for paper recycling and more particularly reclaiming already used papers in conventional copiers and printers by scanning the already used papers and printing the same contest over with color matching the color of the paper. Paper prepared through this process is than reused in copiers and printers or general use. This invention will provide a great impact in environmental protection, reduction in tree cutting and new paper usage.

### DETAILED DESCRIPTION OF INVENTION

The present invention is directed towards paper recycling and reclaiming in the conventional copiers and printers or general use in order to reduce new paper use, tree cutting for paper industry and environmental destruction. The proposed system would be added externally or internally to the existing conventional copiers and printers or used independently for general paper reclaiming. Idea of the invention is to reuse paper sheets that have already been printed on. Such sheets would be put in to the paper feeding tray and from there they will pass through single side or booth side scanner which would read and record previously printed information. In the second stage the printer would print over existing writing with color that matches the paper color (typically white). The printing head to have dispersed action for better coverage. For some special applications multiple color printing head could be used with automatic color matching. Depending on the ink manufacturer and the speed of the process additional ink dryer could be used. This way prepared (cleaned) sheet of the paper is now feed into the conventional copier, printer or for general use.

Previously used paper sheets to feed into the paper feeder (1). Each paper sheet would be carried over with set of rollers (2) through the single or double side scanner (3) which would read and record the information from the sheet. Than the paper would be fed in to the printer area with single or multiple color printing heads (4). On the simpler machines designed for treating the white paper only the single color (white ink) head would be used. For multiple color papers, multiple color head with automatic color matching should be used. Printing heads should be with dispursement action for better coverage. If the OEM ink quality requires, additional ink dryer (5) is to be added as a third stage in the paper processing. This way treated paper is now ready for general use or to be fed into the conventional printers and copiers (6).

What is clamed is:

1. An paper recycling and reclaiming system designed to achieve the paper reusing by scanning previously printed text to achieve dedicated coverage of the said text with same color ink as the color of the paper sheet.

2. An paper recycling and reclaiming system to be attached internally on externally to the conventional copiers or printers.

3. An paper recycling and reclaiming system to be used independently for general usage.

4. Printer head with dispersed action for better coverage.

5. Two side paper treatment in one pass.
